(19) United States
(12) Patent Application Publication
(10) Pub. No.: US 2008/0013974 A1
(43) Pub. Date: Jan. 17, 2008

(54) IMAGE FORMING APPARATUS AND METHOD THEREOF

(75) Inventors: Dae-hyeok Im, Suwon-si (KR); Young-chul Kim, Yongin-si (KR); Sin-ae Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/752,470

(22) Filed: May 23, 2007

(30) Foreign Application Priority Data
Jul. 14, 2006 (KR) 2006-66533

(51) Int. Cl. G03G 15/20

(52) U.S. Cl. 399/67; 399/88

(57) ABSTRACT

An image forming apparatus and method thereof. The image forming apparatus includes a print head having the same size as an image to be printed, a plurality of heating elements that form the image and are arranged in the form of a matrix on the print head, and a plurality of driving elements that correspond to the plurality of heating elements, respectively.

### CROSS-REFERENCE TO RELATED APPLICATIONS

This application claims priority under 35 U.S.C. § 119(a) from Korean Patent Application No. 2006-0066533, filed on Jul. 14, 2006, the disclosure of which is incorporated herein in its entirety by reference.

### BACKGROUND OF THE INVENTION

1. Field of the Invention

The present general inventive concept relates to an image forming apparatus, and more particularly, to an image forming apparatus which is capable of forming an image of high quality and increasing a print speed by eliminating mechanical deviations.

2. Description of the Related Art

A conventional image forming apparatus refers to a copy machine, a printer, a facsimile machine, an MFP (Multi Function Peripheral), etc. The MFP refers to a multifunction terminal implemented by integrating individual terminals, such as a facsimile machine, a scanner, a printer, a copy machine, etc., into one body, and is used independently or through connection to a computer.

FIGS. 1 and 2 illustrate schematic block diagrams of a conventional image forming apparatus. As illustrated in FIG. 1, an image forming apparatus 100 includes a printing part 160 which interacts with a controlling part (i.e., “controller”) 140. The printing part 160 includes a print head 164. FIG. 2 illustrates the image forming apparatus 100 in more detail, including an interface 110 that receives print data and control instructions from a host 190, an input part 120 that receives a selection instruction from a user, a storing part 130 that temporarily stores the received print data, the printing part 160 that performs a print operation, a paper feeding part 150, and the controlling part (i.e., “controller”) 140 that controls the above parts. The printing part 160 further includes a print head driver 162 in addition to the print head 164.

FIG. 3 illustrates a configuration of the paper feeding part 150 of FIG. 2 and its feeding operation according to an operation of a print head 220. The print head 220 includes a group of heating elements 222 and a group of driving elements 224 corresponding to the heating elements 222, respectively, to form an image or text characters on a printing paper 210. The paper feeding part 150 includes a paper feeding motor 232, a feeding roller 234 and a related mechanism 236 to feed the printing paper 210.

In the conventional image forming apparatus of FIGS. 1 through 3, when a print instruction is inputted thereto, the printing paper 210 is picked up and located at a first print row, and the heating elements 222 of the print head 220 are heated to form the image or text characters on the printing paper 210 based on print data. During the printing, as the feeding roller 234 is rotated by driving of the paper feeding motor 232, the printing paper 210 is fed at a specified speed and one side of the printing paper 210 is printed. However, the conventional image forming apparatus has a problem in that the quality of an image may deteriorate by a skew which may occur due to friction between the printing paper 210 and the feeding roller 234 during the feeding, and moreover, the quality of printing may deteriorate due to lowering of precision of parts mechanically abraded with use.

### SUMMARY OF THE INVENTION

The present general inventive concept provides an image forming apparatus which is capable of forming an image of high quality by eliminating mechanical deviations.

The present general inventive concept may also provide a compact image forming apparatus from which parts such as a motor and a feeding roller to feed a printing paper are removed.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing an image forming apparatus comprising a print head having a plurality of heating elements arranged in a form of a matrix to form an image, and a controller to control the print head to form the image at a position corresponding to the heating element on the basis of print data.

The image forming apparatus may further comprise a power supply to supply power to the plurality of heating elements, and a plurality of power supplying elements to connect power to each row of the plurality of heating elements.

The image forming apparatus may further comprise a data supplying part to supply the print data, and a row driver to control the plurality of power supplying elements so that the power is supplied to a print row of the plurality of heating elements.

The data supplying part may comprise a shift register to receive the print data serially and to convert the received print data into parallel print data, and a latch circuit to receive and to hold the parallel print data.

The data supplying part may comprise an AND circuit to perform an AND operation for an output signal of the latch circuit and a strobe signal to drive the plurality of heating elements.

The data supplying part may form the image continuously until gray scales of the print data are represented on a print row of a print paper.

The row driver may control the plurality of power supplying elements so that the power is sequentially supplied to rows of the plurality of heating elements.

The row driver may receive a synchronization signal to define a print row of the print data and may output a signal to control the plurality of power supplying elements sequentially.

The print head may comprise a thermal print head.

The foregoing and/or other aspects and utilities of the present general inventive concept can be achieved by providing an image forming apparatus, comprising a gate driver to output a signal to a plurality of print rows sequentially, a shift register to receive print data and to shift the print data by synchronizing the print data with a clock signal, and a plurality of heating elements arranged in the print rows to print an image corresponding to the print data on a printing paper.

The foregoing and/or other aspects and utilities of the present general inventive concept can be achieved by providing an image forming apparatus, comprising a gate driver to output a signal to a plurality of print rows sequentially, a plurality of heating elements arranged in the print rows to print an image on a printing paper, and a plurality of driving elements to drive the plurality of heating elements in response to the output signal.

The foregoing and/or other aspects and utilities of the present general inventive concept can be achieved by providing a method of an image forming apparatus, the method comprising receiving print data serially, shifting the print data by synchronizing the print data with a clock signal, and driving a plurality of heating elements to print an image corresponding to the print data in response to a synchronization signal.

The foregoing and/or other aspects and utilities of the present general inventive concept can be achieved by providing a method of an image forming apparatus, the method comprising arranging a plurality of heating elements in a form of a matrix on a print head, controlling a plurality of power supplying elements so that the power is supplied to a print row of the plurality of heating elements, and printing an image corresponding to the arrangement of the plurality of heating elements on a printing paper.

The foregoing and/or other aspects and utilities of the present general inventive concept can be achieved by providing a method of an image forming apparatus, the method comprising arranging a plurality of heating elements in a form of a matrix on a print head, supplying print data related to a formation of an image to a column of a plurality of driving elements, and controlling a plurality of power supplying elements so that the power is supplied to a print row of the plurality of heating elements to print the image on a printing paper.

The foregoing and/or other aspects and utilities of the present general inventive concept can be achieved by providing a method of an image forming apparatus, the method comprising supplying print data related to a formation of an image to a column of a plurality of driving elements, and driving a plurality of heating elements corresponding to the driving elements to print the image corresponding to the print data on a printing paper.

The foregoing and/or other aspects and utilities of the present general inventive concept can be achieved by providing an image forming apparatus, comprising a paper feeding part to feed a sheet of paper to a printing position and to maintain the sheet of paper in the printing position until an image is printed without moving with respect to the printing position, and a print head to correspond to the sheet of paper to be maintained in the printing position until the image is printed without moving with respect to the sheet of paper.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIGS. 1 and 2 are block diagrams illustrating a configuration of a conventional image forming apparatus;

FIG. 3 is a view illustrating a feeding operation according to an operation of a print head of the conventional image forming apparatus of FIG. 2;

FIG. 4A is a view illustrating a configuration of an image forming apparatus according to an embodiment of the present general inventive concept;

FIG. 4B is a view illustrating a print head of the image forming apparatus according to an embodiment of the present general inventive concept;

FIG. 5 is a control block diagram of the image forming apparatus according to an embodiment of the present general inventive concept; and

FIG. 6 is a timing diagram illustrating signals applied to the image forming apparatus illustrated in FIG. 5.

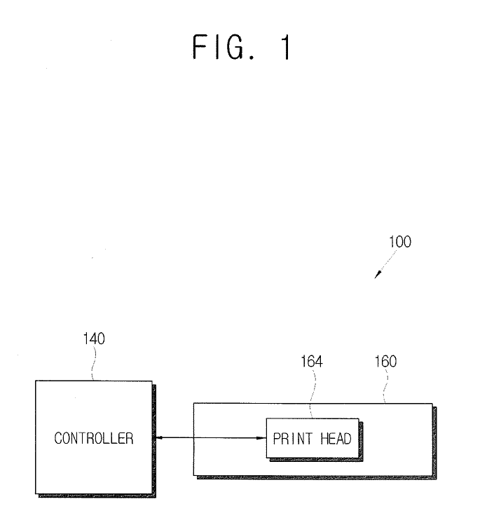

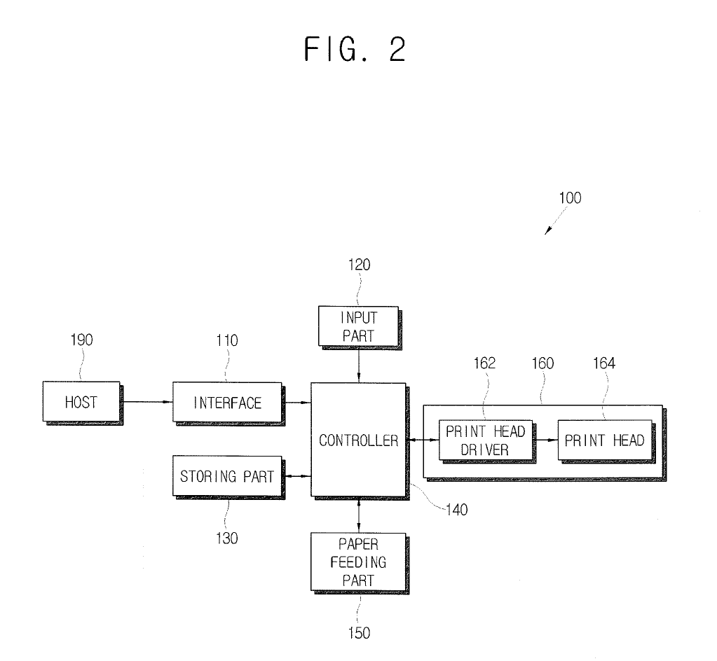

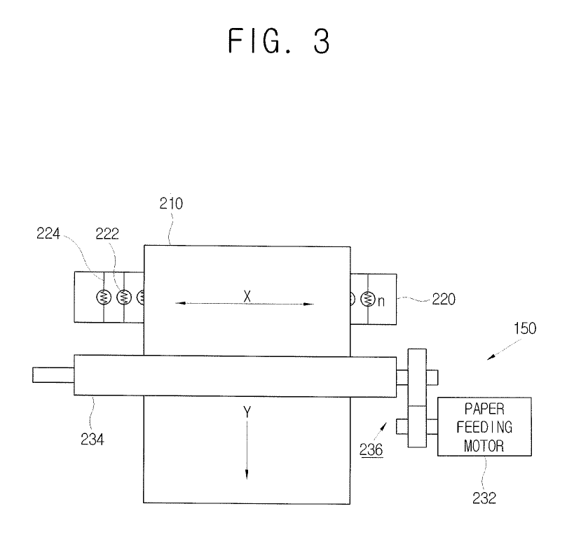

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

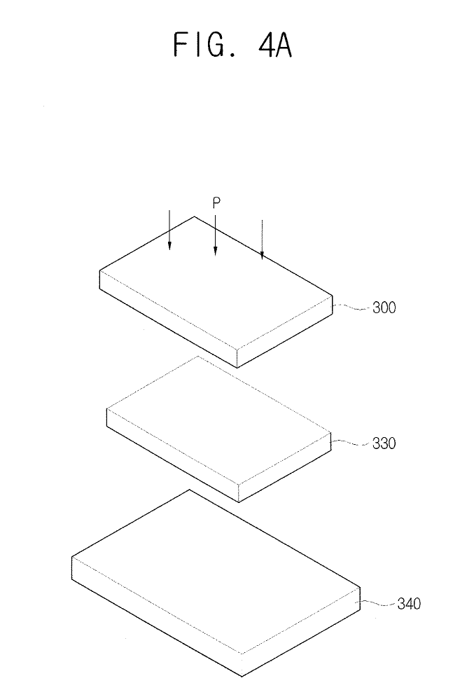

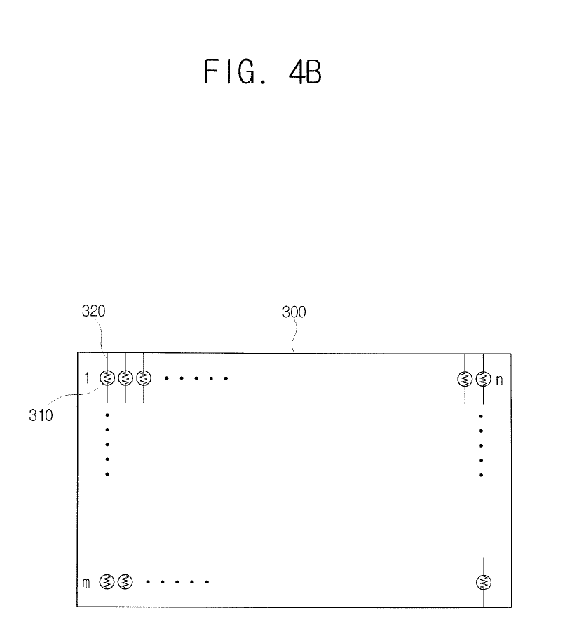

FIG. 4A illustrates a relation between a print head and a printing paper in an image forming apparatus according to an embodiment of the present general inventive concept, and

FIG. 4B illustrates an arrangement of a plurality of nozzles and a plurality of heating elements in the print head.

The image forming apparatus comprises a print head 330, a printing paper 300 and a support 340.

The print head 300 has a plate-like shape with a size corresponding to a printing side of the printing paper 330. The size of the print head may be equal to the size of an image to be printed. The print head 300 may be a thermal print head (TPH) comprising a ceramic insulator and heating elements deposited in a dot pattern on the ceramic insulator.

The print head 300 comprises a group of heating elements 310 and a group of driving elements 320 to form images arranged in row and column directions. The group of the heating elements 310 comprises n heating elements 310 in the row direction and m heating elements 310 in the column direction, thereby being arranged in the form of an n×m matrix.

As illustrated in FIG. 4A, the print head 300 is driven by a pressure to print an image on the printing paper 330 which is positioned on the support 340. Alternatively, the image forming apparatus may employ a structure in which a printing paper in a tray is placed and fixed on the print head 300 by actuation of a mechanism, an image may be printed on the printing paper, and, after printing, the printing paper may be discharged.

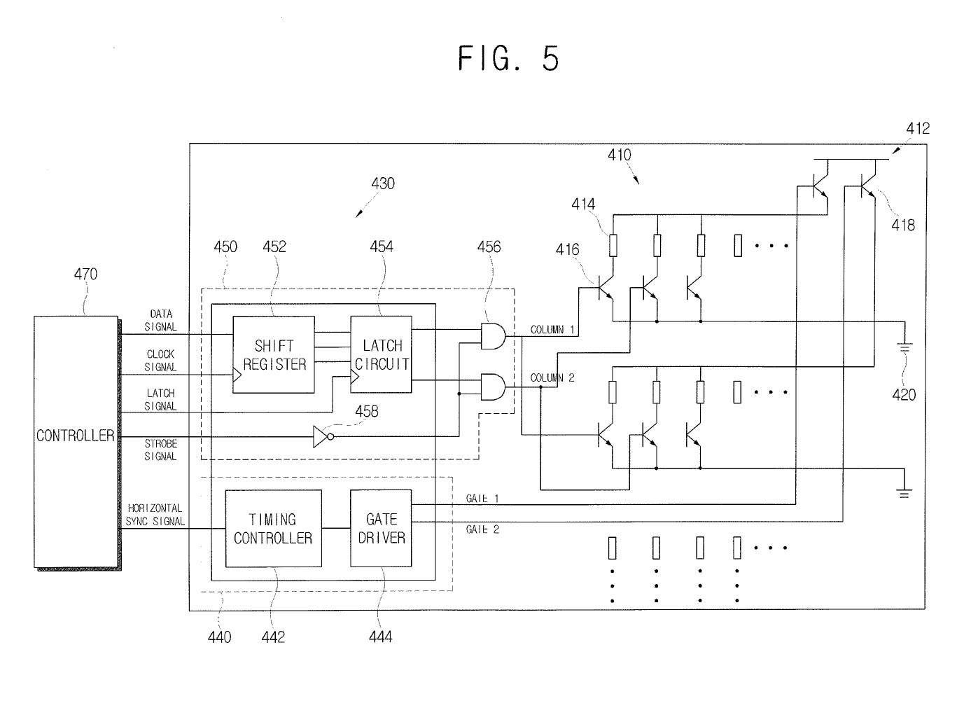

FIG. 5 illustrates a control block diagram of an image forming apparatus comprising a print head 410, a print head driver 430 and a controller 470 in accordance with an embodiment of the present general inventive concept.

The print head 410 comprises a power supply 412, a plurality of heating elements 414, a plurality of driving elements 416, a plurality of power supplying elements 418, and a ground terminal 420.

The plurality of heating elements 414 correspond to a plurality of nozzles of the print head 410, respectively. Typically, the heating elements 414 are heating bodies comprising thin film heaters with resistivity.

The plurality of driving elements 416 comprise switching elements such as transistors (TRs) or field effect transistors (TFTs). The driving elements may be turned on when print data has a high level to drive the heating elements 414.

The power supply 412 supplies power to the plurality of heating elements 414, and the plurality of power supplying elements 418 are connected to rows of the plurality of heating elements 414, respectively, to supply power from the power supply 412 to a row at which the print data is printed.

The print head driver 430 comprises a row driver 440 that controls rows of the heating elements 414, and a data supplying part 450 that supplies the print data to columns of the heating elements 414.

The row driver 440 comprises a timing controller 442 and a gate driver 444. The timing controller 442 receives a horizontal synchronization signal defining a print row of the print data and outputs a control signal to the gate driver 444 to control the rows of the heating elements 414, and the gate driver 444 outputs a signal to sequentially control the power supplying elements 418.

The data supplying part 450 comprises an n-bit shift register 452, an n-bit latch circuit 454, n AND gates 456, and n NOT gates 458.

The n-bit shift register 452 receives serial print data of n bits according to a clock signal received from the controller 470, stores the received serial print data sequentially, and then converts the stored serial print data into parallel print data. The n-bit latch circuit 454 holds the parallel print data for a predetermined period of time. The AND gates 456 perform an AND operation corresponding to output signals of the n-bit latch circuits and strobe signals to drive the heating elements 414.

When the image forming apparatus performs a print operation, the controller 470 transmits the print data serially to the n-bit shift register 452 via a data line according to a clock signal to drive the heating elements 414, and transmits a latch signal to the n-bit latch circuit 454 after completion of the transmission of the print data of n bits. In addition, the controller 470 transmits the horizontal synchronization signal corresponding to each print row to the timing controller 442 to inform the timing controller 442 which row the print data transmitted serially to the n-bit shift register 452 are printed.

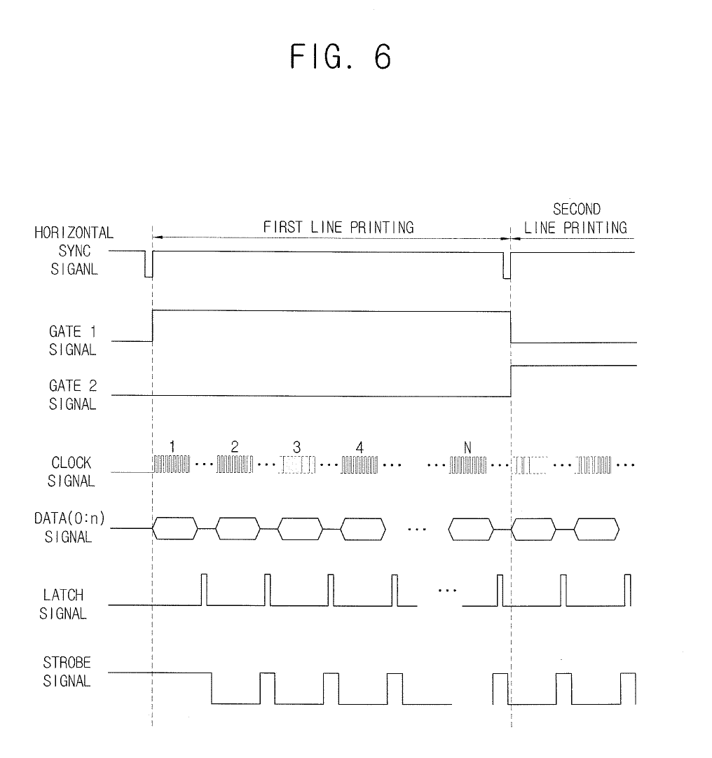

Hereinafter, the operation of the image forming apparatus illustrated in FIG. 5 will be described in detail with reference to a timing diagram illustrated in FIG. 6.

The timing controller 442 of the row driver 440 receives the horizontal synchronization signal from the controller 470 and transmits the horizontal synchronization signal to the gate driver 444, and the gate driver 444 drives the power supplying elements 418 corresponding to each row sequentially whenever the horizontal synchronization signal is input to the gate driver 444. For example, when a first horizontal synchronization signal is input after a print instruction, the timing controller 442 outputs a control signal (i.e., the first synchronization signal) to the gate driver 442 in consideration of timing of the print data provided from the data supplying part 450, and the gate driver 444 outputs a high level signal to its gate-1 according to the control signal. When a second horizontal synchronization signal is input to the timing controller 442, the gate driver 444 outputs a high level signal to its gate-2. In this manner, until an m-th horizontal synchronization signal to drive the last row is input to the timing controller 442, the gate driver 444 outputs a high level signal to the print rows sequentially.

The n-bit shift register 452 of the data supplying part 450 receives the print data serially via a data line and shifts the received print data by synchronizing the received print data with a clock signal. When the n-bit shift register 452 receives data of n bits, the shifted print data is temporarily stored in the n-bit latch circuit 454 by a latch signal. The print data stored in the n-bit latch circuit 454 is supplied to inputs of n AND gates 456, and is held until a next latch signal is input to the n-bit latch circuit 454. Accordingly, a strobe signal is input to the AND gates 456 via the NOT gate 458, as a final print instruction to determine a driving time of the heating elements 414. Since an output signal of the NOT gate 458 has a high level, outputs of n AND gates 456 have a high level or a low level depending on whether the print data has a high level or a low level. If the print data has a high level, the driving elements 416 are turned on, thereby driving the heating elements 414. If the print data has a low level, the driving elements 416 are turned off so that the heating elements 414 can not be driven.

When the horizontal synchronization signal is inputted to the timing controller 442 after the print instruction is input, the gate driver 444 outputs a high level signal to its gate-1. When the gate-1 goes to a high level, since the power supplying elements 418 corresponding to a first row are turned on, power is supplied to a first row of the plurality of heating elements 414. Then, the n-bit shift register 452 receives and shifts the print data in synchronization with the clock signal. When the shift of the n-bit shift register 452 is completed, the n-bit latch circuit 454 receives and temporarily stores the shifted print data from the n-bit shift register 452 by the latch signal. When the strobe signal goes from the high level to the low level, the NOT gate 458 outputs a high level strobe signal and the AND gates 456 output the print data, thereby driving the first row of heating elements 414 to heat the heating elements 414.

Numerals of the print data, 1, 2, 3, . . . , N, are a gray scale representation of color. If N is 256, the print data may be represented with 256 gray scales.

When representation of 256 gray scales at the first row is completed, the timing controller 442 receives the second horizontal synchronization signal and the gate driver 444 outputs a high level signal to the gate-2. When the gate-2 goes to a high level, since the power supplying elements 418 corresponding to a second row are turned on, power is supplied to a second row of the plurality of heating elements 414. Then, when the print data output from the AND gates 456 has a high level, the driving elements at the second row are turned on, thereby driving the heating elements 414 at the second row to print an image on a printing paper.

Although one shift register 452 and one gate driver 444 are illustrated in FIG. 5, if a driving integrated chip (IC) is used instead, a plurality of driving ICs may be employed because there is a limit to the number of bits shifted in the shift register 452 and the number of output terminals of the gate driver 444. In this case, division driving may be realized easily without departing from the scope of the present general inventive concept.

As disclosed above, the present general inventive concept provides an image forming apparatus which is capable of forming an image of high quality by eliminating mechanical deviations occurring at the time of feeding a printing paper and image deviations due to skews occurring at the time of feeding the printing paper.

In addition, according to the present general inventive concept, various printers including a photoprinter can be miniaturized by removing parts such as a motor and a feeding roller to feed a printing paper.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a print head having a plurality of heating elements arranged in a form of a matrix to form an image; and
a controller to control the print head to form the image at a position corresponding to the heating element on the basis of print data.

2. The image forming apparatus according to claim 1, further comprising:
a power supply to supply power to the plurality of heating elements; and
a plurality of power supplying elements to connect power to each row of the plurality of heating elements.

3. The image forming apparatus according to claim 1, further comprising:
a data supplying part to supply the print data; and
a row driver to control the plurality of power supplying elements so that the power is supplied to a print row of the plurality of heating elements.

4. The image forming apparatus according to claim 3, wherein the data supplying part comprises:
a shift register to receive the print data serially and to convert the received print data into parallel print data; and
a latch circuit to receive and to hold the parallel print data.

5. The image forming apparatus according to claim 4, wherein the data supplying part comprises an AND circuit to perform an AND operation for an output signal of the latch circuit and a strobe signal to drive the plurality of heating elements.

6. The image forming apparatus according to claim 3, wherein the data supplying part forms the image continuously until gray scales of the print data are represented on a print row of a print paper.

7. The image forming apparatus according to claim 3, wherein the row driver controls the plurality of power supplying elements so that the power is sequentially supplied to rows of the plurality of heating elements.

8. The image forming apparatus according to claim 7, wherein the row driver receives a synchronization signal to define a print row of the print data and outputs a signal to control the plurality of power supplying elements sequentially.

9. The image forming apparatus according to claim 2, further comprising:
a data supplying part to supply print data related to a formation of the image to a column of the plurality of driving elements; and
a row driver to control the plurality of power supplying elements so that the power is supplied to a print row of the plurality of heating elements.

10. The image forming apparatus according to claim 9, wherein the data supplying part comprises:
a shift register to receive the print data serially and to convert the received print data into parallel print data; and
a latch circuit to receive and to hold the parallel print data.

11. The image forming apparatus according to claim 10, wherein the data supplying part comprises an AND circuit to perform an AND operation for an output signal of the latch circuit and a strobe signal to drive the plurality of heating elements.

12. The image forming apparatus according to claim 9, wherein the data supplying part forms the image continuously until gray scales of the print data are represented on a print row of a print paper.

13. The image forming apparatus according to claim 9, wherein the row driver controls the plurality of power supplying elements so that the power is sequentially supplied to rows of the plurality of heating elements.

14. The image forming apparatus according to claim 13, wherein the row driver receives a synchronization signal to define a print row of the print data and outputs a signal to control the plurality of power supplying elements sequentially.

15. The image forming apparatus according to claim 1, wherein the print head comprises a thermal print head.

16. An image forming apparatus, comprising:
a gate driver to output a signal to a plurality of print rows sequentially;
a shift register to receive print data and to shift the print data by synchronizing the print data with a clock signal; and
a plurality of heating elements arranged in the print rows to print an image corresponding to the print data on a printing paper.

17. An image forming apparatus, comprising:
a gate driver to output a signal to a plurality of print rows sequentially;
a plurality of heating elements arranged in the print rows to print an image on a printing paper; and
a plurality of driving elements to drive the plurality of heating elements in response to the output signal.

18. A method of an image forming apparatus, the method comprising:
receiving print data serially;
shifting the print data by synchronizing the print data with a clock signal; and
driving a plurality of heating elements to print an image corresponding to the print data in response to a synchronization signal.

19. A method of an image forming apparatus, the method comprising:
arranging a plurality of heating elements in a form of a matrix on a print head;
controlling a plurality of power supplying elements so that the power is supplied to a print row of the plurality of heating elements; and
printing an image corresponding to the arrangement of the plurality of heating elements on a printing paper.

20. A method of an image forming apparatus, the method comprising:
arranging a plurality of heating elements in a form of a matrix on a print head;
supplying print data related to a formation of an image to a column of a plurality of driving elements; and
controlling a plurality of power supplying elements so that the power is supplied to a print row of the plurality of heating elements to print the image on a printing paper.

21. A method of an image forming apparatus, the method comprising:
supplying print data related to a formation of an image to a column of a plurality of driving elements; and
driving a plurality of heating elements corresponding to the driving elements to print the image corresponding to the print data on a printing paper.

22. An image forming apparatus, comprising:
a paper feeding part to feed a sheet of paper to a printing position and to maintain the sheet of paper in the printing position until an image is printed without moving with respect to the printing position; and
a print head to correspond to the sheet of paper to be maintained in the printing position until the image is printed without moving with respect to the sheet of paper.
